(19) United States
(12) Patent Application Publication
(10) Pub. No.: US 2026/0010824 A1
(43) Pub. Date: Jan. 8, 2026

(54) METHODS AND SYSTEMS FOR DE-BIASING MACHINE LEARNING MODELS

(71) Applicant: MASTERCARD INTERNATIONAL INCORPORATED, PURCHASE, NY (US)

(72) Inventors: Puspita MAJUMDAR, Kolkata (IN); Ankit KHAIRKAR, Pune (IN); Balraj PRAJESH, Ghaziabad (IN); Harsh KUMAR, Halsi (IN); Jaipal Singh KUMAWAT, Sikar (IN); Raghav SHARMA, Jaipur (IN); Rohit BHATTACHARYA, Kolkata (IN)

(21) Appl. No.: 18/766,416

(22) Filed: Jul. 8, 2024

(51) Int. Cl. G06N 20/00

(52) U.S. Cl. CPC G06N 20/00

(57) ABSTRACT

Methods and systems for de-biasing Machine Learning models are disclosed. Method performed by a server system includes accessing multiple features associated with a data point in an imbalanced input dataset and generating, by an embedding generation model, a biased embedding for the data point. Method includes segregating the multiple features into a set of downstream task features and a set of sensitive task features. Method includes computing, by a first classification model, a biased task-specific embedding based on the biased embedding and the set of downstream task features. Method includes computing, by a second classification model, a sensitive attribute-specific embedding based on the biased embedding and the set of sensitive task features. Method includes computing an unbiased embedding for the biased embedding based on the biased task-specific embedding and the sensitive attribute-specific embedding.

### TECHNICAL FIELD

The present disclosure relates to artificial intelligence-based processing systems and, more particularly, to electronic methods and complex processing systems for de-biasing Machine Learning models.

### BACKGROUND

Over the years, rapid technological advancements have led to the usage of Artificial Intelligence (AI) and/or Machine Learning (ML) models or algorithms in almost every field including healthcare, education, finance, and the like. Such AI/ML models are used to perform a wide variety of tasks, such as classification tasks, anomaly detection, pattern recognition, speech recognition, and so on. As may be understood, AI algorithms generally tend to reflect biases present in society. These algorithms may inherit or in some cases even amplify the biases that may be present in training datasets used for training and validating such models. These biases could be unintended cognitive biases or real-life prejudice which got introduced into the model due to incomplete, faulty, or prejudicial training datasets. More specifically, the bias in the models could be related to sensitive user attributes, such as age, gender, race, etc., among other sensitive attributes. During the training or learning process, models identify patterns associated with sensitive attributes, introducing correlations that affect predictions and compromise fairness. Alternatively, the bias could be due to unbalanced data points for different classes in the training dataset. Other examples include an income prediction system that can be biased to a majority class, a loan approval decision model trained on historical loan approval datasets for processing loan applications that can also get biased to a majority class, cross-border transaction prediction algorithms that can be biased based on geography and culture, consumer segmentation models for marketing can be demographically biased, and the like.

To eliminate such biases, over the years, several strategies and techniques have been implemented to restore the integrity of such AI or ML models. However, most of the conventional debiasing techniques have several drawbacks, such as complexity in model architecture, restriction in the usage of sensitive attributes, a trade-off between accuracy and fairness, and the like. For instance, some conventional approaches that try to mitigate bias fail to maintain or improve the accuracy of the models due to dropping out of features related to sensitive attributes from the training dataset. As may be known, more number and variation in the input features of any AI/ML model improves its performance and accuracy. Removal of at least a few features will have a negative impact on the performance and accuracy of the model.

Thus, there exists a need for technical solutions, such as improved methods and systems for de-biasing ML models while overcoming the aforementioned technical drawbacks.

### SUMMARY

Various embodiments of the present disclosure provide methods and systems for de-biasing one or more Machine Learning models.

In an embodiment, a computer-implemented method for de-biasing one or more Machine Learning models is disclosed. The computer-implemented method performed by a server system includes accessing a plurality of features associated with a data point in an imbalanced input dataset from a database associated with the server system. The method further includes generating, by an embedding generation model associated with the server system, a biased embedding for the data point based, at least in part, on the plurality of features. The method includes segregating the plurality of features into a set of downstream task features and a set of sensitive task features based, at least in part, on the biased embedding. Further, the method includes computing, by a first classification model associated with the server system, a biased task-specific embedding based, at least in part, on the biased embedding and the set of downstream task features. Furthermore, the method includes computing, by a second classification model associated with the server system, a sensitive attribute-specific embedding based, at least in part, on the biased embedding and the set of sensitive task features. The method includes computing an unbiased embedding for the biased embedding based, at least in part, on the biased task-specific embedding and the sensitive attribute-specific embedding.

In another embodiment, a server system is disclosed. The server system includes a communication interface and a memory including executable instructions. The server system also includes a processor communicably coupled to the memory. The processor is configured to execute the instructions to cause the server system, at least in part, to access a plurality of features associated with a data point in an imbalanced input dataset from a database associated with the server system. The server system is also caused to generate, by an embedding generation model associated with the server system, a biased embedding for the data point based, at least in part, on the plurality of features. The server system is further caused to segregate the plurality of features into a set of downstream task features and a set of sensitive task features based, at least in part, on the biased embedding. Further, the server system is caused to compute, by a first classification model associated with the server system, a biased task-specific embedding based, at least in part, on the biased embedding and the set of downstream task features. Furthermore, the server system is caused to compute, by a second classification model associated with the server system, a sensitive attribute-specific embedding based, at least in part, on the biased embedding and the set of sensitive task features. The server system is caused to compute an unbiased embedding for the biased embedding based, at least in part, on the biased task-specific embedding and the sensitive attribute-specific embedding.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a plurality of features associated with a data point in an imbalanced input dataset from a database associated with the server system. The method further includes generating, by an embedding generation model associated with the server system, a biased embedding for the data point based, at least in part, on the plurality of features. The method includes segregating the plurality of features into a set of downstream task features and a set of sensitive task features based, at least in part, on the biased embedding. Further, the method includes computing, by a first classification model associated with the server system, a biased task-specific embedding based, at least in part, on the biased embedding and the set of downstream task features. Furthermore, the method includes computing, by a second classification model associated with the server system, a sensitive attribute-specific embedding based, at least in part, on the biased embedding and the set of sensitive task features. The method includes computing an unbiased embedding for the biased embedding based, at least in part, on the biased task-specific embedding and the sensitive attribute-specific embedding.

### BRIEF DESCRIPTION OF THE FIGURES

For a more complete understanding of example embodiments of the present technology, reference is now made to the following descriptions taken in connection with the accompanying drawings in which:

FIG. 1A illustrates a schematic representation of an environment related to at least some example embodiments of the present disclosure;

FIG. 1B illustrates a schematic representation of an environment related to at least some example embodiments of the present disclosure;

FIG. 2 illustrates a simplified block diagram of a server system, in accordance with an embodiment of the present disclosure;

FIG. 3 illustrates a block diagram of an architecture for de-biasing a Machine Learning (ML) model, in accordance with an embodiment of the present disclosure;

FIG. 4 illustrates a block diagram for performing a federated learning mechanism within an environment related to at least some example embodiments of the present disclosure;

FIGS. 5A and 5B, collectively, illustrate a flow diagram depicting a method for de-biasing an ML model, in accordance with an embodiment of the present disclosure;

FIG. 6 illustrates a simplified block diagram of an acquirer server, in accordance with an embodiment of the present disclosure;

FIG. 7 illustrates a simplified block diagram of an issuer server, in accordance with an embodiment of the present disclosure; and

FIG. 8 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The term “bias” used throughout the description refers to a type of systematic inaccuracy in research and engineering. Biases can be inherent or acquired. Further, bias in the mathematical field of statistics results from unfair population sampling or estimating techniques that don't produce results that are generally correct. Further, in Machine Learning (ML), bias refers to a phenomenon that occurs when an algorithm of an AI or ML model produces results that are systemically prejudiced due to erroneous assumptions made during a training process of the ML model. This generally occurs when the said AI or ML model is trained using data that is inherently biased due to various factors.

The terms “bias mitigation” and “de-biasing” have been interchangeably used throughout the description and generally refer to the prevention and reduction of biases or negative effects of the biases on human judgment and decision-making that reliably produce reasoning errors. Further, it refers to mitigating prejudice in AI or ML models using one or more techniques.

The terms “sensitive attributes” and “protected attributes” have been used interchangeably throughout the description and generally refer to personal attributes or characteristics of an individual that are not supposed to be disclosed. For instance, the sensitive attributes include age, gender, ethnicity, race, income, etc., among other suitable sensitive attributes.

### Overview

Various embodiments of the present disclosure provide methods, systems electronic devices, and computer program products for de-biasing Machine Learning (ML) models. In an embodiment, the present disclosure describes a server system that is configured to access an imbalanced input dataset from a database associated with the server system. The imbalanced input dataset includes historical information corresponding to at least one user. The historical information includes a plurality of data points having an imbalanced label distribution. The server system can further generate the plurality of features for each data point corresponding to the at least one user based, at least in part, on the imbalanced input dataset. The server system may store the plurality of features in the database which can be accessed in the future for further processing.

In one embodiment, the server system accesses the plurality of features associated with a data point in the imbalanced input dataset from the database. Further, the server system can generate a biased embedding for the data point based, at least in part, on the plurality of features. In one embodiment, the server system may generate the biased embedding using an embedding generation model associated with the server system. The server system segregates the plurality of features into a set of downstream task features and a set of sensitive task features based, at least in part, on the biased embedding. Further, the server system computes a biased task-specific embedding based, at least in part, on the biased embedding and the set of downstream task features. In one embodiment, the server system may compute the biased task-specific embedding by a first classification model associated with the server system.

The server system then computes a sensitive attribute-specific embedding based, at least in part, on the biased embedding and the set of sensitive task features. In one embodiment, the server system computes the sensitive attribute-specific embedding by a second classification model associated with the server system. Further, the server system computes an unbiased embedding for the biased embedding based, at least in part, on the biased task-specific embedding and the sensitive attribute-specific embedding. In one embodiment, the server system may further update a weight associated with the data point in the imbalanced input dataset based, at least in part, on an embedding generation loss value, a first loss value, and a second loss value. Further, the server system may compute an overall loss value for the data point based, at least in part, on the embedding generation loss value, the first loss value, the second loss value, and the weight associated with the data point.

In some embodiments, the server system may generate a reconstructed output for the data point based, at least in part, on the plurality of features. In an example implementation, the server system may generate the reconstructed output using the embedding generation model. Further, the server system may compute the embedding generation loss value associated with the embedding generation model based, at least in part, on the reconstructed output and an original input data point.

In some other embodiments, the server system may generate a prediction for the data point based, at least in part, on the unbiased embedding, the prediction being related to the main task. In an example implementation, the server system may generate the prediction by the first classification model. Further, the server system may compute the first loss value associated with the first classification model based, at least in part, on the prediction and an actual outcome for the data point.

Further, in some embodiments, the server system may generate a sensitive attribute prediction for the data point based, at least in part, on the sensitive attribute-specific embedding. In an example implementation, the server system may generate the sensitive attribute prediction by the second classification model. The server system may further compute the second loss value associated with the second classification model based, at least in part, on the sensitive attribute prediction and an actual sensitive attribute of the data point.

During a training phase of the embedding generation model, the server system may train the embedding generation model to generate a biased embedding for a training dataset based, at least in part, on performing a first set of operations until an embedding generation loss value converges to a first predefined condition. In one embodiment, the first set of operations can include: (i) initializing the embedding generation model based, at least in part, on one or more embedding generation model parameters; (ii) generating, by an encoder of the embedding generation model, a biased embedding based, at least in part, on the plurality of features; (iii) generating, by a decoder of the embedding generation model, a reconstructed output based, at least in part, on the biased embedding; (iv) computing the embedding generation loss value based, at least in part, on the reconstructed output, an original input, and an embedding generation loss function; (v) computing an embedding generation gradient component based, at least in part, on backpropagating the embedding generation loss value; and (vi) optimizing the one or more embedding generation model parameters based, at least in part, on the embedding generation gradient component.

Similarly, during the training phase of the first classification model, the server system may train the first classification model to generate the biased task-specific embedding for a training dataset based, at least in part, on performing a second set of operations until a first loss value converges to a second predefined condition. The second set of operations may include: (i) initializing the first classification model based, at least in part, on one or more first classification model parameters; (ii) generating, by the first classification model, a biased task-specific embedding based, at least in part, on the biased embedding and a set of downstream task features; (iii) generating, by the first classification model, a prediction corresponding to the downstream task based, at least in part, on the biased task-specific embedding; (iv) computing the first loss value based, at least in part, on the prediction, a true task-specific label, and a first loss function; (v) computing a first gradient component based, at least in part, on backpropagating the first loss value; and (vi) optimizing the one or more first classification model parameters based, at least in part, on the first gradient component.

Further, during the training phase of the second classification model, the server system may train the second classification model to generate the sensitive attribute-specific embedding for a training dataset based, at least in part, on performing a third set of operations until a second loss value converges to a third predefined condition. The third set of operations may include: (i) initializing the second classification model based, at least in part, on one or more second classification model parameters; (ii) generating, by the second classification model, a sensitive attribute-specific embedding based, at least in part, on the biased embedding and a set of sensitive task features; (iii) generating, by the second classification model, a prediction corresponding to a sensitive attribute classification task based, at least in part, on the sensitive attribute-specific embedding; (iv) computing the second loss value based, at least in part, on the prediction, a true sensitive attribute label, and a second loss function; (v) computing a second gradient component based, at least in part, on backpropagating the second loss value; and (vi) optimizing the one or more second classification model parameters based, at least in part, on the second gradient component.

Various embodiments of the present disclosure offer multiple advantages and technical effects. For instance, the present disclosure aims to solve the technical problem of how to effectively remove/reduce biases from one or more Artificial Intelligence (AI) or Machine Learning (ML) models. For instance, the present disclosure forces the model to learn features related to the main task and ignore or suppress the features related to the sensitive attributes during training for unbiased model prediction without simply disregarding the said features. This aspect ensures that the performance of the model is maintained at a desirable level. Further, the present disclosure boosts the model performance by assigning different weights to each sample of different classes using adaptive reweighing. As a result, the trade-off between accuracy and fairness is addressed.

Further, de-biasing the models helps financial institutions promote financial inclusion as it ensures equal access to all services, thus providing a fair playing field to people of all backgrounds. Furthermore, the approach disclosed in the present disclosure also helps the financial institutions avoid legal, ethical, and reputational risks that may have been raised from biased predictions of the models. Moreover, the approach proposed in the present disclosure is more advantageous over conventional methods in a way that the present approach does not drop features but rather suppresses the features related to sensitive attributes while enhancing features for the main task prediction.

For example, for performing the main task of predicting cancer patients in a demographic area, a model trained with a historical dataset related to several patients in the corresponding area may be considered. This model can be a biased model having biases such as sensitive attribute-related biases, biases due to imbalance data points distribution between different classes (i.e., cancer class and non-cancer class), and the like. The sensitive attribute-related biases can be introduced when the historical dataset has a greater number of data points for a particular sensitive attribute. The biases due to imbalance data point distribution between different classes can be introduced when the historical dataset has a greater number of data points for a particular class (i.e., a non-cancer class which is a majority class) and a smaller number of data points for another class (i.e., cancer class which is a minority class as cancer is a rarely occurring disease).

To mitigate sensitive attribute-related biases, during the training phase of an ML model, sensitive task features are suppressed over main task features using other ML models. As a result, unfairness in the prediction of the main task due to the sensitive attributes is eliminated. Further, to mitigate biases due to imbalance data points distribution between different classes, the concept of adaptive reweighing is applied. This enhances the model performance by assigning more weight to data points of the minority class than that of the majority class. As a result, the trade-off between accuracy and fairness is addressed.

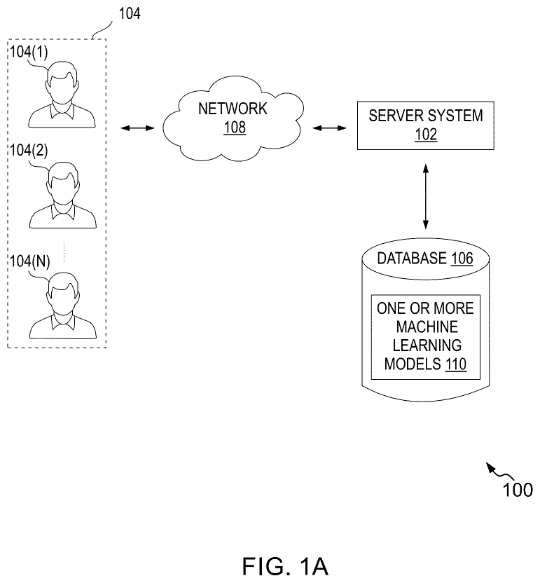

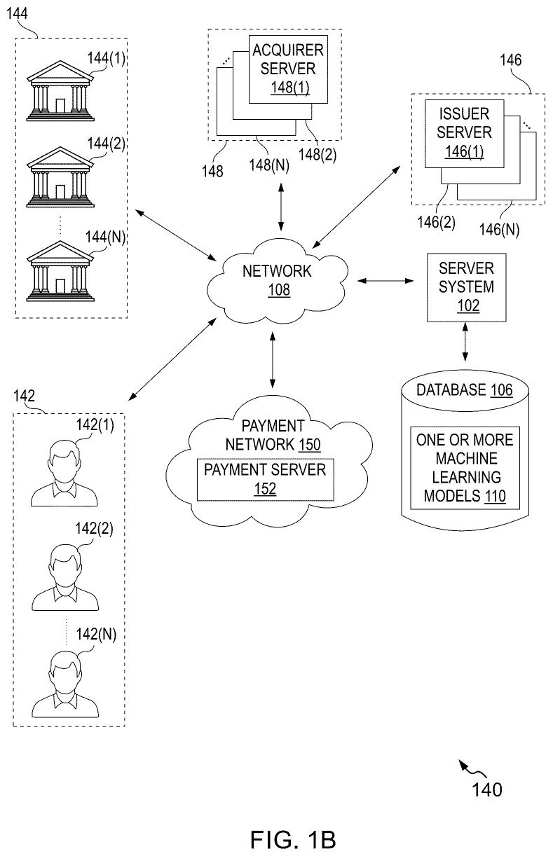

Various example embodiments of the present disclosure are described hereinafter with reference to FIG. 1A and FIG. 1B to FIG. 8.

FIG. 1A illustrates a schematic representation of an environment 100 related to at least some example embodiments of the present disclosure. Although the environment 100 is presented in one arrangement, other embodiments may include the parts of the environment 100 (or other parts) arranged otherwise depending on, for example, generating embeddings that have inherent biases, de-biasing the embeddings, optimizing an overall loss value by adaptive reweighing, and the like.

The environment 100 generally includes a plurality of entities, such as a server system 102, a plurality of users 104(1), 104(2), . . . 104(N) (collectively referred to hereinafter as a ‘plurality of users 104’ or simply, ‘users 104’), a database 106, each coupled to, and in communication with (and/or with access to) a network 108. Herein, it may be noted that ‘N’ is a non-zero natural number.

As may be understood, Artificial Intelligence (AI) or Machine Learning (ML) models have to be trained with historical data (or training data) over a period of time, before they can be used for generating predictions related to a particular task. In a specific embodiment, the task may include, but is not limited to, speech recognition, image classification, email spam detection, performing medical diagnosis, fraud detection, risk management, charge-back decision-making systems, payment authorization systems, data analytics, credit card scoring systems, cross-border transaction management systems, consumer segmenting, and the like. These AI or ML models are trained to learn the underlying patterns associated with the training data, and based on the learned pattern, the models have to generate predictions on real-time data upon testing and validation of the trained model.

In some scenarios, the training data could be affected by biases towards a particular demography, gender, race, or the like. For example, the training data with which the AI or ML model is trained to predict whether an individual can get a loan or not, is data from a time period when in a particular demographic location, a greater number of people of a majority class used to have jobs and would apply for loans and get it granted than its counterparts (i.e., a minority class). Upon completion of the learning process, such a model would have inherited the pattern of the majority class being the category who are most likely to get a loan request granted over the minority class or people from the majority class may be given loan approvals for higher amounts than its counterparts. Thus, during the prediction phase, the model might exhibit biased behavior by predicting higher approval rates for people belonging to the majority class over the minority class, even when the financial qualifications of people belonging to both classes are the same. As a result, even today where people belonging to both the classes have equivalent qualifications, people from the majority class are more likely to be granted a loan over the minority class if such biased models are used. Another example includes fraud detection and risk management which can become biased towards a majority class by considering people belonging to the particular majority class are more likely to be classified as fraudsters or risky in comparison to the minority class. Herein, the reason for such a bias may be rooted in historical data used for training one or more AI or ML models. The historical data include data that during a certain period had labels indicating a greater number of people of a particular class (i.e., the majority class) were found guilty of committing some frauds than people from another class (i.e., the minority class).

In some other scenarios, the number of data points for each class in a training dataset used for training a model for performing a binary classification task would be unevenly distributed. For example, for predicting cancer patients in a demographic area, consider a model trained with historical data related to several patients in the corresponding area. Since cancer is a rare disease, the training data may have data points of which only a small percentage correspond to a cancer disease category (called as a minority category). As a result, during the prediction phase, the model may unintentionally become biased toward predicting majority category (i.e., non-cancer) patients more frequently due to this imbalance between data points of the different categories. In addition, the model may learn features that are specific to the majority category and not generalize well to detect cancer cases. Moreover, the model may also have a higher tendency to generate false positives.

Thus, mitigating biases, such as a sensitive attribute-related bias and a representation bias or under-representation (i.e., bias due to an imbalanced training dataset) from the AI or ML models is required. Conventional approaches address either the sensitive attribute-related bias or the representation bias and face a trade-off between accuracy and fairness. Therefore, the above-mentioned technical problems, among other problems, are addressed by one or more embodiments implemented by the server system 102 and the methods thereof provided in the present disclosure. It should be noted that the server system 102 is targeted to configure a model architecture of one or more AI or ML models such that the above-mentioned biases are mitigated from the models with greater accuracy and preciseness.

In one embodiment, a user (e.g., the user 104(2)) from the users 104 may refer to any individual who is involved in at least one of using systems to train the AI or ML models and use them for performing the above-mentioned tasks. For example, the user 104(1) may be any individual, representative of a person, an object, a place or a location, an institution, an organization, a corporate entity, a non-profit organization, medical facilities (e.g., hospitals, laboratories, etc.), educational institutions, government agencies, telecom industries, or the like.

In another embodiment, the users (e.g., the users 104(2)-104(N)) may correspond to individuals whose data is used for training the models. For example, patients who are undergoing treatment for certain diseases, and data generated corresponding to such patients can be used to learn and understand the experience of the patients at a particular clinical center. Thus, such data is used to train AI or ML models to identify diseases and diagnosis, such as classifying different diseases, such as, cancer using images, predicting the progression of pre-diabetes, predicting response to depression treatment, etc. In the specific implementation of the payment industry (as shown in FIG. 1B), the users 104(2)-104(N) may be cardholders, account holders, merchants, consumers, issuers, acquirers, banks, third-party users, financial institutions, or the like.

In some embodiments, the users 104(2)-104(N) may use their corresponding electronic devices (not shown in figures) to access a mobile application or a website associated with the issuing bank, or any third-party payment application to perform a payment transaction. In various non-limiting examples, the electronic devices may refer to any electronic devices, such as, but not limited to, Personal Computers (PCs), tablet devices, smart wearable devices, Personal Digital Assistants (PDAs), voice-activated assistants, Virtual Reality (VR) devices, smartphones, laptops, and the like.

The network 108 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users illustrated in FIG. 1A, or any combination thereof.

Various entities in the environment 100 may connect to the network 108 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 108 may utilize a secure protocol (e.g., Hypertext Transfer Protocol (HTTP), Secure Socket Lock (SSL), and/or any other protocol, or set of protocols for communicating with the various entities depicted in FIG. 1A.

In a specific embodiment, the server system 102 may facilitate the user 104(1) such as an institute involved in de-biasing one or more AI or ML models while training the AI or ML models to perform a downstream task. In order to do that, the server system 102 may have to access an input dataset which is assumed to be imbalanced. In one embodiment, the database 106 is configured to store the imbalanced input dataset which may be split into an imbalanced training dataset, an imbalanced validation dataset, and an imbalanced testing dataset. During a training phase, the imbalanced training dataset may be used by the server system 102 for training the AI or ML models to mitigate bias from such models. Upon training the models, real-time data may be applied to such models and de-biased or fair predictions may be obtained.

In one embodiment, the imbalanced input dataset may include historical information corresponding to at least one user (e.g., the user 104(2)) from the users 104. The historical information may include a plurality of data points having an imbalanced label distribution. For instance, a greater number of data points (e.g., the payment transactions) are classified under one particular class, and a smaller number of data points under another class within the imbalanced input dataset. In another embodiment, the imbalanced input dataset may include historical information corresponding to a plurality of activities performed by the user 104(2) in a predefined domain. Herein, the plurality of activities may include purchase, transaction, consultation, loan request, and the like based on the predefined domain of implementation. In some embodiments, the predefined domain may include any domain, field, or industry, such as healthcare, finance, travel, retail, and the like.

In one embodiment, the server system 102 is configured to access the imbalanced input dataset from the database 106, generate a plurality of features for the user 104(2), and store the features in the database 106 that can be accessed in the future for further processing. The database 106 may also store one or more AI or ML models (e.g., one or more ML models 110) that need to be de-biased for performing the downstream task with fairness and accuracy. In one embodiment, the database 106 may be incorporated in the server system 102 or may be an individual entity connected to the server system 102 or may be a database stored in cloud storage.

In various non-limiting examples, the database 106 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database 106. In one implementation, the database 106 may be viewed, accessed, amended, updated, and/or deleted by an administrator (not shown) associated with the server system 102 through a database management system (DBMS) or relational database management system (RDBMS) present within the database 106.

In an embodiment, the server system 102 is further configured to access the plurality of features for each data point in the imbalanced input dataset corresponding to the user 104(2) from the database 106. In one embodiment, the server system 102 is configured to develop an architecture with a combination of the one or more AI or ML models 110 that can be used in mitigating bias while training at least one of the AI or ML models 110 to perform the downstream task such as a binary classification task. In a non-limiting implementation, the one or more AI or ML models 110 may include at least an embedding generation model, a first classification model, and a second classification model. Herein, the first classification model may be trained to perform the downstream task and is assumed to be associated with biases. Thus, the server system 102 is configured to de-bias the first classification model using the other models such as the embedding generation model and the second classification model. Similarly, the embedding generation model may be trained to generate an embedding representing a compressed learning representation for each data sample of the imbalanced input dataset. The second classification model is trained to perform a sensitive attribute prediction task. The process of training each of these models is explained later in detail in the present disclosure.

In one embodiment, the server system 102 is configured to access a plurality of features associated with a data point in the imbalanced input dataset from the database 106. The server system 102 is further configured to generate a biased embedding for the data point based, at least in part, on the plurality of features. In one embodiment, the server system 102 may generate the biased embedding using the embedding generation model. Further, the server system 102 may be configured to segregate the plurality of features into a set of downstream task features and a set of sensitive task features based, at least in part, on the biased embedding.

Furthermore, the server system 102 may be configured to compute a biased task-specific embedding based, at least in part, on the biased embedding and the set of downstream task features. In one embodiment, the server system 102 may compute the biased task-specific embedding using the first classification model. The server system 102 may further be configured to compute a sensitive attribute-specific embedding based, at least in part, on the biased embedding and the set of sensitive task features. In one embodiment, the server system 102 may compute the sensitive attribute-specific embedding using the second classification model. The server system 102 may be configured to compute an unbiased embedding for the biased embedding based, at least in part, on the biased task-specific embedding and the sensitive attribute-specific embedding.

In one embodiment, the server system 102 may be configured to update a weight associated with the data point in the imbalanced input dataset based, at least in part, on an embedding generation loss value, a first loss value, and a second loss value. Herein, the embedding generation loss value may be associated with the embedding generation model, the first loss value may be associated with the first classification model, and the second loss value may be associated with the second classification model. Further, the server system 102 may be configured to compute an overall loss value for the data point based, at least in part, on the embedding generation loss value, the first loss value, the second loss value, and the weight associated with the data point. It should be noted that the above-mentioned configuration steps performed by the server system 102 may be iteratively performed until the overall loss value converges to a predefined de-biasing condition. In one embodiment, the predefined de-biasing condition is a saturation of the overall loss value. The overall loss value is saturated after a plurality of iterations of the configuration steps are performed by the server system 102.

It should be noted that performing the above-mentioned configuration steps iteratively, eventually, mitigates biases associated with the first classification model. Upon de-biasing, a de-biased first classification model may be obtained from the first classification model. The de-biased first classification model may be used for generating debiased predictions related to the downstream task. The process associated with the generation of the biased task-specific embedding, the sensitive attribute-specific embedding, the unbiased task-specific embedding, and the optimization of the overall loss value is explained later in detail in the present disclosure.

It should be understood that the server system 102 is a separate part of the environment 100, and may operate apart from (but still in communication with, for example, via the network 108) any third-party external servers (to access data such as the training datasets to perform the various operations described herein). However, in other embodiments, the server system 102 may be incorporated, in whole or in part, into one or more parts of the environment 100.

In an embodiment, it may be noted that the methods and systems proposed in the present disclosure can be used in any domain or industry to perform any downstream tasks. However, for the sake of explanation, analysis, and performance comparison, the various embodiments of the proposed system are applied in the payment industry. However, the same should not be construed as a limitation, and the various embodiments of the present disclosure are applicable in various other industries such as healthcare, retail, media, travel, crime detection, and the like, and the same would be covered within the scope of the present disclosure as well.

Thus, in a non-limiting implementation of the present disclosure in the healthcare industry, the server system 200 may train a medical diagnosis model (e.g., the first classification model 222) to generate predictions related to a medical diagnosis of a patient based on the imbalanced input dataset 218, such as medical history of the patient and a historical medical diagnosis-related dataset corresponding to a plurality of patients. Herein, the medical diagnosis model can be biased with respect to a particular sensitive attribute. For instance, medical diagnosis is related to predicting whether the patient is suffering from cancer or not. In such an application, suppose the historical medical diagnosis-related dataset includes a greater number of people in a group of people belonging to a majority class (i.e., belonging to a particular class of sensitive attribute) that might have suffered from cancer than their counterparts. Also, suppose the historical medical diagnosis-related dataset includes an imbalance distribution of data points between different main task classes (i.e., cancer class and non-cancer class). For example, a greater number of data points under the non-cancer class (otherwise also referred to as a majority class) and a smaller number of data points under the cancer class (otherwise also referred to as a minority class) as cancer is a rarely occurring disease. Further, if such a dataset is used to train the medical diagnosis model, then the predictions generated by the medical diagnosis model on a real-time dataset are most likely to make incorrect predictions. Herein, most of the predictions are more likely to be biased toward the majority class of the sensitive attributes and the main task classes.

As a result, the server system 200 trains the medical diagnosis model to generate the embeddings based at least on a training dataset extracted from the historical medical diagnosis-related dataset for a training period. Initially, the embedding generation module 230 of the server system 200 generates the biased embedding using the embedding generation model 220. Later, the classification module 232 of the server system 200 computes the biased task-specific embedding using the medical diagnosis model. The classification module 232 further computes the sensitive attribute-specific embedding using the second classification model 224. Later, the de-biasing module 234 computes the unbiased embedding for the biased embedding from the above-computed embeddings. Upon computing the unbiased embedding, biases in the predictions of the medical diagnosis model due to the sensitive attributes are suppressed. However, the accuracy of the predictions remains the same due to the imbalance distribution of data points between different main task classes. The bias die to such an imbalance is suppressed by adjusting weights assigned to each data point in the imbalanced input dataset 218 during the training phase using the concept of adaptive reweighing. In this approach, the weights of data points for the cancer class are set for a higher value compared to that for the non-cancer class. This way all the data points, irrespective of the class will be given approximately equal importance. As a result, biases due to the imbalance distribution of data points under different classes are also mitigated.

The number and arrangement of systems, devices, and/or networks shown in FIG. 1A is provided as an example. There may be additional systems, devices, and/or networks; fewer systems, devices, and/or networks; different systems, devices, and/or networks; and/or differently arranged systems, devices, and/or networks than those shown in FIG. 1A. Furthermore, two or more systems or devices are shown in FIG. 1A may be implemented within a single system or device, or a single system or device is shown in FIG. 1A may be implemented as multiple, distributed systems or devices. In addition, the server system 102 should be understood to be embodied in at least one computing device in communication with the network 108, which may be specifically configured, via executable instructions, to perform steps as described herein, and/or embodied in at least one non-transitory computer-readable media.

FIG. 1B illustrates a schematic representation of an environment 140 related to at least some example embodiments of the present disclosure. Although the environment 140 is presented in one arrangement, other embodiments may include the parts of the environment 140 (or other parts) arranged otherwise depending on, operations performed similar to that performed in the environment 100. Thus, it should be noted that the environment 140 is an example implementation of the environment 100, with the environment 140 representing a financial industry in which the users 104 can be at least one of cardholders and merchants. Thus, the data points of the environment 100 may correspond to payment transactions performed between the cardholders and the merchants in the environment 140.

In one embodiment, the environment 140 includes entities, such as the server system 102, a plurality of cardholders 142(1), 142(2), . . . 142(N) (collectively referred to hereinafter as a ‘plurality of cardholders 142’ or simply ‘cardholders 142’), a plurality of merchants 144(1), 144(2), . . . 144(N) (collectively referred to hereinafter as a ‘plurality of merchants 144’ or simply ‘merchants 144’), a plurality of issuer servers 146(1), 146(2), . . . 146(N) (collectively referred to hereinafter as a ‘plurality of issuer servers 146’ or simply ‘issuer servers 146’), a plurality of acquirer servers 148(1), 148(2), . . . , 148(N) (collectively referred to hereinafter as a ‘plurality of acquirer servers 148’ or simply ‘acquirer servers 148’), a payment network 150 including a payment server 152, and the database 106 each coupled to, and in communication with (and/or with access to) the network 108. Herein, it may be noted that ‘N’ is a non-zero natural number that may be different for each entity.

As used herein, the term “cardholder” refers to a person who has a payment account or a payment card (e.g., credit card, debit card, etc.) associated with the payment account, that will be used by a merchant to perform a payment transaction. The payment account may be opened via an issuing bank or an issuer server. Similarly, as used herein, the term “merchant” refers to a seller, a retailer, a purchase location, an organization, or any other entity that is in the business of selling goods or providing services, and it can refer to either a single business location or a chain of business locations of the same entity. Further, as used herein, the term “payment network” refers to a network or collection of systems used for the transfer of funds through the use of cash substitutes. Payment networks are companies that connect an issuing bank with an acquiring bank to facilitate online payment. In an example, the cardholders 142 may use their corresponding electronic devices to access a mobile application or a website associated with the issuing bank, or any third-party payment application to perform a payment transaction.

In one embodiment, the payment network 150 may be used by the payment card issuing authorities as a payment interchange network. Examples of the payment cards include debit cards, credit cards, etc. A payment interchange network allows for the exchange of electronic payment transaction data between issuers and acquirers. The payment network 150 includes the payment server 152 which is responsible for facilitating the various operations of the payment network 150. In one scenario, the payment server 152 is configured to operate a payment gateway for facilitating the various entities in the payment network 150 to perform digital transactions.

It is to be noted that due to the complexity of a banking network, a cardholder 142(1) and a merchant 144(1) may be associated with the same banking institution, e.g., ABC Bank. In such a situation, the ABC Bank will act as an issuer for the cardholder 142(1) and an acquirer for the merchant 144(1). Thus, a banking institution may act as both an acquirer and/or an issuer depending on the needs of its clients.

As may be understood, the one or more AI or ML models that are specifically trained for predicting results for financial domain-related tasks can be associated with the above-mentioned biases. For example, in a historical transaction dataset, only 1% of payment transactions are fraudulent and the rest of the 99% are non-fraudulent thereby, making it an imbalanced dataset. If such an imbalanced dataset is used to train an AI or ML model, then the predictions that the model might generate on a real-time dataset are most likely to make incorrect predictions and most of the predictions are more likely to be biased toward the majority class (i.e., the non-fraudulent class) and fail to detect the actual fraudulent cases. As a result, the server system 102 proposed in the present disclosure may be used to de-bias such models.

In one embodiment, the server system 102 may facilitate payment processors to mitigate bias while training the one or more AI or ML models to predict a downstream task. Further, it may be noted that, in a specific example, the server system 102 coupled with the database 106 is embodied within a payment server (e.g., the payment server 152) associated with the payment processor, however, in other examples, the server system 102 can be a standalone component (acting as a hub) connected to the issuer servers 146 and the acquirer servers 148.

In one embodiment, the imbalanced input dataset may include a cardholder-related dataset. Along with the cardholder-related dataset, the database 106 may also store a merchant-related dataset and any other historical information that may be related to a plurality of payment transactions performed between the cardholders 142 and the merchants 144 in a payment ecosystem.

In an example, the historical information may include, but is not limited to, transaction attributes, such as transaction amount, source of funds such as bank accounts, debit cards or credit cards, transaction channel used for loading funds such as POS terminal or ATM, transaction velocity features such as count and transaction amount sent in the past ‘x’ number of days to a particular user, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, and other transaction-related data.

In other various examples, the database 106 may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data.

By accessing the imbalanced input dataset, the server system 102 is configured to train the one or more AI or ML models to generate de-biased predictions for the downstream task by performing various operations. It should be noted that the operations are explained above with reference to FIG. 1A and not described again for the sake of brevity. In the payment ecosystem, it may be understood that information corresponding to sensitive attributes related to the cardholders 142 is not accessible to anyone due to security purposes, except for the issuer servers 146 as the cardholders 142 have their payment accounts created with the issuer servers 146 for facilitating online payment transactions. Therefore, to gain insights from these features, the server system 102 in the payment ecosystem may utilize a federated learning mechanism. Herein, the federated learning mechanism refers to a mechanism in which AI or ML models are trained in a decentralized manner such that only insights are shared with other AI or ML models. Thus, preserving the privacy of the sensitive attributes associated with the cardholders 142.

In such a scenario, upon the computation of the biased embedding, the server system 102 may be configured to transmit a sensitive task request to the issuer server (e.g., the issuer server 146(1)). In one embodiment, the sensitive task request may indicate a request for a sensitive attribute-specific embedding for a sensitive attribute such as a gender type corresponding to each cardholder. The sensitive task request may further include the biased embedding.

In response to the sensitive task request, the issuer server 146(1) may be configured to perform the task of predicting the sensitive attribute of the cardholder 142(1) based, at least in part, on the biased embedding. During the process of training the second classification model at the issuer server 146(1) to predict the sensitive attribute, a sensitive attribute-specific embedding may be generated at every iteration. A final sensitive attribute-specific embedding obtained from the second classification model upon convergence of the second loss value associated with the second classification model may be transmitted back to the server system 102. Thus, in an embodiment, the server system 102 may further be configured to receive the sensitive attribute-specific embedding from the issuer server 146(1). Upon receiving the sensitive attribute-specific embedding, the server system 102 may compute the unbiased embedding and perform the rest of the operations similar to as explained earlier with reference to FIG. 1A.

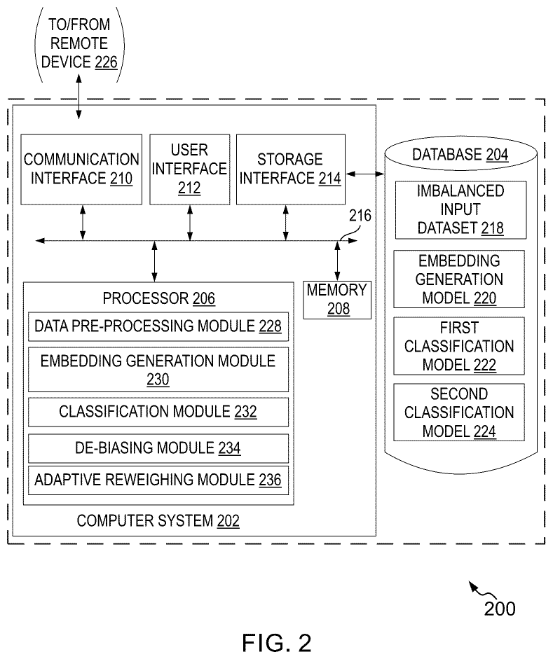

FIG. 2 illustrates a simplified block diagram of a server system 200, in accordance with an embodiment of the present disclosure. The server system 200 is identical to the server system 102 of FIGS. 1A and 1B. In some embodiments, the server system 200 is embodied as a cloud-based and/or software as a service (SaaS)-based architecture.

The server system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one non-limiting example, the database 204 is configured to store an imbalanced input dataset 218 and one or more AI or ML models, such as an embedding generation model 220, a first classification model 222, a second classification model 224, and the like. In a non-limiting example, as mentioned earlier in the present disclosure, the imbalanced input dataset 218 may include the historical information related to a user (e.g., the user 104(2)). Suppose the first classification model 222 may be trained to generate predictions for a main downstream task such as a classification task. Then, it should be noted that other models of the one or more AI or ML models may be arranged and/or connected and are trained for mitigating bias from the first classification model 222. Thus, in one embodiment, the database 204 may also be configured to store information related to the one or more AI or ML models.

As may be understood, the imbalanced input dataset 218 may be split into an imbalanced training dataset, an imbalanced validation dataset, and an imbalanced testing dataset, and used during the training phase, the validation phase, and the testing phase, respectively. Upon efficiently training the one or more AI or ML models for de-biasing the first classification model 222, a real-time dataset may be applied to the first classification model 222 and de-biased predictions may be obtained for the downstream task performed by the first classification model 222.

In one embodiment, in supervised learning, the imbalanced input dataset 218 may be a labeled dataset. For training a model to perform a classification task using the concept of supervised learning, the labeled dataset can be used. In some embodiments, the labeled dataset may have data points that have uniformly distributed labels. In some other embodiments, the labeled dataset may have data points that have non-uniformly distributed labels. Hence such a dataset can also be referred to as the imbalanced training dataset of the imbalanced input dataset 218.

For instance, while training a model for fraud detection in payment transactions, the imbalanced input dataset 218 may include a plurality of historical transactions with an imbalanced label distribution for fraud and non-fraud labels. In another instance, for medical diagnostic testing, the imbalanced input dataset 218 may include details related to multiple patients with imbalanced label distribution for labels ‘yes’ or ‘no’. Therefore, it may be understood that the imbalanced input dataset 218 may vary based on the task that needs to be performed.

In addition, the database 204 provides a storage location for data and/or metadata obtained from various operations performed by the server system 200. In one embodiment, the database 204 is substantially similar to the database 106 of FIGS. 1A and 1B. Thus, it should be understood that all the details, data, or information as mentioned in the description of FIGS. 1A and 1B to be stored in the database 106 are applicable for the database 204 as well.

Further, the computer system 202 may include one or more hard disk drives as the database 204. The user interface 212 is an interface, such as a Human Machine Interface (HMI) or a software application that allows users such as an administrator to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for accessing the imbalanced input dataset 218 and features, generating biased embeddings, segregating the features into downstream task-specific features and sensitive task-specific features, computing a biased task-specific embedding, a sensitive attribute-specific embedding, and an unbiased embedding, updating weights associated data points in the imbalanced input dataset 218, computing an overall loss value, de-biasing the first classification model 222, and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 226, such as the issuer servers 146, the acquirer servers 148, the payment network 150, or communicating with any entity connected to the network 108 (as shown in FIG. 1A).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 228, an embedding generation module 230, a classification module 232, a de-biasing module 234, and an adaptive reweighing module 236. It should be noted that components, described herein, such as the data pre-processing module 228, the embedding generation module 230, the classification module 232, the de-biasing module 234, and the adaptive reweighing module 236 can be configured in a variety of ways, including electronic circuitries, digital arithmetic, and logic blocks, and memory systems in combination with software, firmware, and embedded technologies. Moreover, it may be noted that the data pre-processing module 228, the embedding generation module 230, the classification module 232, the de-biasing module 234, and the adaptive reweighing module 236 may be communicably coupled with each other to exchange information with each other for performing the one or more operations facilitated by the server system 200.

In one embodiment, the data pre-processing module 228 includes suitable logic and/or interfaces for accessing the imbalanced input dataset 218 from the database 204. In one embodiment, the imbalanced input dataset 218 may include historical information corresponding to the at least one user (e.g., the user 104(2)). The historical information may include a plurality of data points having an imbalanced label distribution. The data pre-processing module 228 may further be configured to generate a plurality of features for each data point corresponding to the user 104(2) based, at least in part, on the imbalanced input dataset 218. Further, the plurality of features may be stored in the database 204. Herein, it should be noted that, during the training phase, the imbalanced input dataset 218 may include the imbalanced training dataset, during the validation phase, it may include the imbalanced validation dataset, and during the testing phase, it may include the imbalanced testing dataset. Further, during the deployment phase, real-time data may be provided to the first classification model 222 upon mitigating it with biases if any.

It may be understood that the plurality of features may correspond to insights, useful information, and relevant patterns that are obtained upon preprocessing the imbalanced input dataset 218 for improving the model's performance. In a non-limiting example, preprocessing the imbalanced input dataset 218 may include performing several operations on the imbalanced input dataset 218 to make the imbalanced input dataset 218 suitable for training. For instance, the operations may include removing noise, feature engineering, feature selection, data cleaning, handling missing values, normalizing or scaling data, analyzing characteristics of the data, and converting the imbalanced dataset 218 into a format that the AI or ML models can process. Since these operations are well known in the art, the same has not been described herein for the sake of brevity.

For instance, the imbalanced input dataset 218 can correspond to an adult dataset, which is a publicly available dataset. In an embodiment, the adult dataset may include about 65,123 samples, each with about 11 attributes. Features associated with such a dataset may include, but are not limited to, age, work class, education, marital status, occupation, relationship, and the like. The features may also include sensitive attributes, such as gender, race, ethnicity, and the like. The features and/or the imbalanced input dataset 218 may also include a binary label. For instance, the binary label may indicate whether an individual's annual income exceeds $50,000 which can serve as a target variable. Herein, it should be noted that pre-defined training, validation, and testing sets may be taken from the imbalanced input dataset 218 that streamlines model training and evaluation processes.

Further, the data pre-processing module 228 may be configured to access the plurality of features for each data point in the imbalanced input dataset 218 from the database 204. Upon accessing the plurality of features, a pattern associated with the features may have to be learned and captured in a model for further processing. This can be done by generating an embedding (i.e., latent representation) for the features corresponding to each data point in the imbalanced input dataset 218. By generating the embedding for the features, dimensionality reduction, information compression, generalization, improvement in model performance, improvement in interoperability, efficient storage and transmission, enhanced privacy, and the like can be achieved across various applications or tasks. Thus, the features may be provided to the embedding generation module 230 for facilitating the generation of the embedding.

In one embodiment, the embedding generation module 230 includes suitable logic and/or interfaces for generating a biased embedding for each data point corresponding to the user 104(2), based, at least in part, on the plurality of features. In one embodiment, the embedding generation module 230 may generate the biased embedding using the embedding generation model 220. Herein, since the input to the embedding generation model 230 corresponds to the features associated with the imbalanced input dataset 218, the embedding generation model 220 may have propagated the bias from the input to the output, i.e., the embedding. As a result, the embedding generated for the corresponding features is referred to as the biased embedding.

In one embodiment, the embedding generation module 230 may be configured to train the embedding generation model 220 to generate the biased embedding using a training dataset of the imbalanced input dataset 218. For training the embedding generation model 220, the embedding generation module 230 may have to perform a first set of operations iteratively until an embedding generation loss value converges to a first predefined condition. Herein, the embedding generation loss value may refer to an error associated with the output of the embedding generation model 220 in comparison to an actual output that needs to be generated. Further, in one embodiment, the first predefined condition is a saturation of the embedding generation loss value. The embedding generation loss value is saturated after a plurality of iterations of the first set of operations is performed. Herein, saturation may refer to a stage in the model training process after a certain number of iterations where a loss value (e.g., the embedding generation loss value) becomes constant, i.e., the difference in the loss value for one iteration and its subsequent iteration becomes the same or negligible. The loss of any model is associated with model performance, so, the less the loss the better the model performance. Hence, certain parameters associated with the model may be modified to reduce the loss value, thereby improving the model performance. Thus, the biased embedding generated by the embedding generation model 220 may be an accurate latent representation of the features provided as input to the embedding generation model 220.

In one embodiment, the first set of operations may include: (i) initializing the embedding generation model 220 based, at least in part, on one or more embedding generation model parameters; (ii) generating, by an encoder of the embedding generation model 220, a biased embedding based, at least in part, on the plurality of features; (iii) generating, by a decoder of the embedding generation model 220, a reconstructed output based, at least in part, on the biased embedding; (iv) computing the embedding generation loss value based, at least in part, on the reconstructed output, an original input, and an embedding generation loss function; (v) computing an embedding generation gradient component based, at least in part, on backpropagating the embedding generation loss value; and (vi) optimizing the one or more embedding generation model parameters based, at least in part, on the embedding generation gradient component.

In a non-limiting example, the one or more embedding generation model parameters may include encoder weights and biases, decoder weights and biases, an activation function, loss function parameters, learning rate, epoch, and the like. The one or more embedding generation model parameters may also include one or more hyperparameters, such as a number of neurons in a hidden layer of a Neural Network (NN) of the model, a number of layers, a type of an optimizer, a batch size, and the like. Further details of the training process and utilization of the embedding generation model 220 in de-biasing the first classification model 222 are explained later in detail in the present disclosure.

It should be noted that the biased embedding includes features (a set of downstream task features) for the downstream task such as the main classification task as well as features (a set of sensitive task features) for a sensitive attribute classification task. For mitigating the bias in the implementation of the downstream task, more focus should be on the set of downstream task features whereas, less focus on the set of sensitive task features. Thus, the biased embedding is provided to the classification module 232 for further processing.

In one embodiment, the classification module 232 includes suitable logic and/or interfaces for segregating the plurality of features into the set of downstream task features and the set of sensitive task features based, at least in part, on the biased embedding. Further, the classification module 232 may be configured to compute a biased task-specific embedding based, at least in part, on the biased embedding and the set of downstream task features. In one embodiment, the classification module 232 may compute the biased task-specific embedding using the first classification model 222.

In one embodiment, the classification module 232 may be configured to train the first classification model 222 to generate the biased task-specific embedding using a training dataset of the imbalanced input dataset 218. The training process may be similar to that of the embedding generation model 220. Thus, for training the first classification model 222, the classification module 232 may have to perform a second set of operations iteratively until a first loss value converges to a second predefined condition. Herein, the first loss value may refer to an error associated with the output of the classification model 222 in comparison to an actual output that needs to be generated. Further, in one embodiment, the second predefined condition is saturation of the first loss value. The first loss value is saturated after a plurality of iterations of the second set of operations is performed.

In one embodiment, the second set of operations may include: (i) initializing the first classification model 222 based, at least in part, on one or more first classification model parameters; (ii) generating, by the first classification model 222, the biased task-specific embedding based, at least in part, on the biased embedding and the set of downstream task features; (iii) generating, by the first classification model 222, a prediction corresponding to the downstream task based, at least in part, on the biased task-specific embedding; (iv) computing the first loss value based, at least in part, on the prediction, a true task-specific label, and a first loss function; (v) computing a first gradient component based, at least in part, on backpropagating the first loss value; and (vi) optimizing the one or more first classification model parameters based, at least in part, on the first gradient component.

In a non-limiting example, the one or more first classification model parameters may include a number of input features in an input layer, a number of layers in a hidden layer, a number of neurons in each layer, a number of neurons in an output layer, an activation function, and the like. The one or more first classification model parameters may also include one or more hyperparameters, such as a loss function, an optimizer, learning rate, batch size, number of epochs, and the like. Further details of the training process and de-biasing of the first classification model 222 are explained later in detail in the present disclosure.

The classification module 232 may further be configured to compute a sensitive attribute-specific embedding based, at least in part, on the biased embedding and the set of sensitive task features. In one embodiment, the classification module 232 may compute the biased task-specific embedding using the second classification model 224.

In one embodiment, the classification module 232 may be configured to train the second classification model 224 to generate the sensitive attribute-specific embedding using a training dataset of the imbalanced input dataset 218. The training process may be similar to that of the second classification model 224. Thus, for training the second classification model 224, the classification module 232 may have to perform a third set of operations iteratively until a second loss value converges to a third predefined condition. Herein, the process of determining the second loss value and the third predefined condition is similar to that for the first loss value and the second predefined condition, and hence the explanation for the same is not provided herein for the sake of brevity.

In one embodiment, the third set of operations may include: (i) initializing the second classification model 224 based, at least in part, on one or more second classification model parameters; (ii) generating, by the second classification model 224, the sensitive attribute-specific embedding based, at least in part, on the biased embedding and the set of sensitive task features; (iii) generating, by the second classification model 224, a prediction corresponding to a sensitive attribute classification task based, at least in part, on the sensitive attribute-specific embedding; (iv) computing the second loss value based, at least in part, on the prediction, a true sensitive attribute label, and a second loss function; (v) computing a second gradient component based, at least in part, on backpropagating the second loss value; and (vi) optimizing the one or more second classification model parameters based, at least in part, on the second gradient component. In a non-limiting example, the one or more second classification model parameters may be similar to that of the first classification model 222.

In one embodiment, the biased task-specific embedding and the sensitive attribute-specific embedding may be provided to the de-biasing module 234 for further processing. Further, the de-biasing module 234 includes suitable logic and/or interfaces for computing an unbiased embedding for the biased embedding based, at least in part, on the biased task-specific embedding and the sensitive attribute-specific embedding. The process of computing the unbiased embedding is explained later in detail in the present disclosure.

It is to be noted that upon the generation of the unbiased embedding for the imbalanced input dataset 218, biases in the predictions of the first classification model 222 due to the sensitive attributes may be suppressed or removed. However, the accuracy of the predictions may remain the same as the imbalance in the imbalanced input dataset 218 is still present. The bias due to such an imbalance may be suppressed by adjusting weights assigned to each data point in the imbalanced input dataset 218 during the training phase.

In a specific embodiment, the adjustment of the weights may be implemented by applying the concept of adaptive reweighing. Herein, the term ‘adaptive reweighing’ refers to a method of dynamically adjusting weights assigned to data points in a training dataset of the imbalanced input dataset 218 based on the class distribution. Herein, higher importance is given to minority class data points, and less importance is given to majority class data points based on the assignment of the weights to each data point. Thus, making the model more sensitive to patterns within that particular class (i.e., the minority class). As a result, the bias due to the imbalance in the training dataset is mitigated.

Moreover, the adjustment of the weights may be dependent on loss values generated from each model involved in de-biasing the first classification model 222 and the loss associated with the first classification model 222 itself. Thus, in an embodiment, the embedding generation loss value, the first loss value, and the second loss value may be provided to the adaptive reweighing module 236.

In one embodiment, the adaptive reweighing module 236 includes suitable logic and/or interfaces for updating a weight associated with each data point in the imbalanced input dataset 218 based, at least in part, on the embedding generation loss value, the first loss value, and the second loss value. Further, the adaptive reweighing module 236 may be configured to compute an overall loss value for each data point based, at least in part, on the embedding generation loss value, the first loss value, the second loss value, and the weight associated with each data point. The process of the application of the concept of adaptive reweighing on the first classification model 222 for de-biasing the first classification model 222 is explained later in detail in the present disclosure.

Moreover, in an embodiment, the de-biasing module 234 may be configured to de-bias the first classification model 222 based, at least in part, on performing operations associated with each module of the processor 206 iteratively until the overall loss value for the data point converges to a predefined de-biasing condition. In one embodiment, the predefined de-biasing condition is a saturation of the overall loss value. The overall loss value is saturated after a plurality of iterations of the above-mentioned operations are performed.

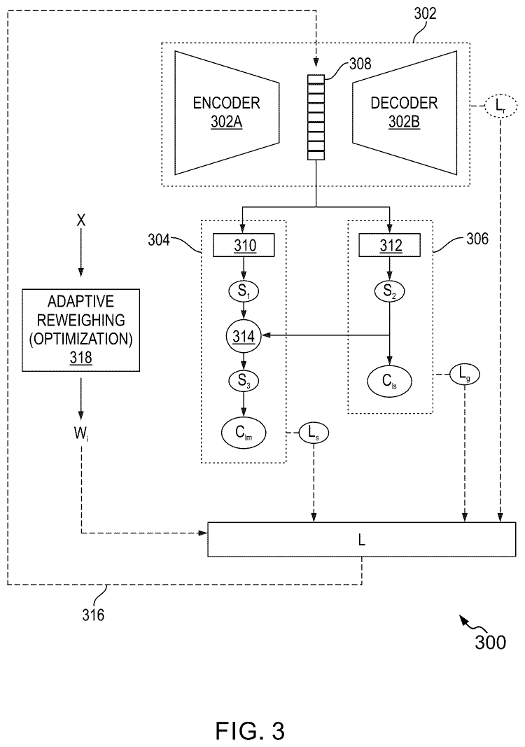

FIG. 3 illustrates a block diagram 300 of an architecture for de-biasing a ML model, in accordance with an embodiment of the present disclosure. As may be understood, the architecture proposed in the present disclosure for bias mitigation may include an embedding generation model 302, a first classification model 304, and a second classification model 306. Herein, the embedding generation model 302, the first classification model 304, and the second classification model 306 are similar to the embedding generation model 220, the first classification model 222, and the second classification model 224, respectively.

In one embodiment, the server system 200 is configured to train the embedding generation model 302 to generate the biased embedding 308 for each data point which is an optimized biased embedding based at least on the implementation of the first set of operations described with reference to FIG. 2. In one non-limiting example, the embedding generation model 302 can be one of an autoencoder, a transformer-based model, a Convolutional Neural Network (CNN), a temporal-based model, and the like. Further, the embedding generation model 302 may be chosen based on the application for which the embeddings are generated. In a non-limiting implementation, the autoencoder may be used in the present disclosure. In a specific implementation, the autoencoder includes an encoder 302A and a decoder 302B. As may be understood, the encoder 302A may be configured to compress the imbalanced input dataset 218 into a lower-dimensional representation, i.e., the biased embedding 308. The decoder 302B may be configured to reconstruct the input (i.e., the imbalanced input dataset 218) from the biased embedding 308. Thus, the server system 200 may be further configured to generate a reconstructed output for each data point/sample based, at least in part, on the plurality of features. However, there is a possibility that the reconstructed output may not exactly match the input. Thus, the server system 200 may also be configured to compute the embedding generation loss value (Lᵣ) associated with the embedding generation model 302 based, at least in part, on the reconstructed output and an original input data point (X).

In a non-limiting implementation, the embedding generation loss value (Lᵣ) may be computed using the embedding generation loss function. It should be noted that a reconstruction loss such as a Root Mean Square Error (RMSE) may be computed using the embedding generation loss function. In a non-limiting example, the embedding generation loss function may be represented by the following equation:

$${L}_{r} = \frac{{\sum }_{i = 0}^{i = n} {( {\hat{y}}_{l} - {y}_{i} )}^{2}}{n} \qquad Eqn . 1$$

Herein, ‘n’ is the total number of data points in the imbalanced input dataset 218, ‘yᵢ’ represents the original input data point, and ‘ŷᵢ’ represents the reconstructed output data point by the autoencoder. The embedding generation loss value may be used further for optimization of the architecture for de-biasing.

It should be noted that the structure of the autoencoder is adaptable. As a result, the number of layers and the architecture size associated with the autoencoder can be modified based on the application for which they are chosen. The usage of the autoencoder may be advantageous as it provides dimensionality reduction, feature learning, and noise reduction. Further, the autoencoder learns a compressed, lower-dimensional representation in a latent space, capturing meaningful patterns in the imbalanced input dataset 218. Moreover, the autoencoder can also capture complex relationships between the data points in the imbalanced input dataset 218.

Further, the biased embedding 308 may be split into two branches, where a first branch is dedicated to predicting a main downstream task using the first classification model 304, and a second branch is dedicated to predicting a sensitive attribute task using the second classification model 306. As may be understood, the first classification model 304, and the second classification model 306, each include a fully connected layer 310 and 312, respectively. Further, since the architecture of the classification models includes a Neural Network (NN), fully connected layers 310 and 312 may include an input layer, one or more hidden layers, and an output layer, each having a respective count of neurons. Herein, each neuron is applied with an activation function to introduce non-linearity in the output of each layer. It should be noted that the one or more embedding generation model parameters may be initialized and accordingly the architecture described herein may be arranged or altered.

In one embodiment, from the fully connected layer 310, the biased task-specific embedding (S₁) may be obtained. Similarly, from the fully connected layer 312, the sensitive attribute-specific embedding (S₂) may be obtained. Further, the server system 200 may be configured to compute the unbiased embedding (S₃) based at least on the biased task-specific embedding and the sensitive attribute-specific embedding. In one embodiment, the server system 200 may compute the unbiased embedding by performing a predefined arithmetic operation. In a non-limiting example, the predefined arithmetic operation can be represented by the following equation:

$${S}_{3} = {S}_{1} * ( 1 - {S}_{2} ) \qquad Eqn . 2$$

Herein, it should be noted that the unbiased embedding (S₃) is devoid of biases associated with sensitive attributes. Further, in one embodiment, the NN used for each of the classification models can be a Multilayer Perceptron (MLP) classifier, each dedicated to performing a main classification task and predicting sensitive attributes, respectively. Thus, the output layer of the first classification model 304 can be termed as a task-specific classifier node (Cₗₘ) as it is applied with a softmax operation to perform the final classification operation. Similarly, the output layer of the second classification model 306 can be termed as a sensitive task classifier node (Cₗₛ) upon the application of the softmax operation on the corresponding node to perform the prediction of the sensitive attribute. In a non-limiting implementation, the NN can be one of logistic regression, support vector classifier (SVC), various tree-based models, and the like.

During the process of training the first classification model 304, the first loss value (Lₛ) may be computed using the first loss function. In a non-limiting example, the equation for the first loss function that is used for computing the first loss value for i^{th} sample (data point) in the imbalanced input dataset 218 can be represented as follows:

$${L}_{s} = {\sum }_{i = 0}^{i = n} ( {w}_{i} ) * ( - {y}_{i} * log ( {p}_{i} ) - ( 1 - {y}_{i} ) * log ( 1 - {p}_{i} ) ) \qquad Eqn . 3$$

Herein, ‘n’ is the total number of data points in the imbalanced input dataset 218, ‘yᵢ’ represents a true label for the sensitive attribute (0 or 1), and ‘pᵢ’ represents the predicted probability of the sensitive attribute being 1. Also, the first loss value for the i^{th} sample is multiplied by the weight ‘wᵢ’, which is the weight assigned to the i^{th} sample. The embedding generation loss value may be used further for optimization of the architecture for de-biasing.

Further, during the training of the second classification model 306. The second loss value (L_{g}) may be computed using the second loss function. In a non-limiting example, the equation for the second loss function that is used for computing the second loss value can be represented as follows:

$${L}_{g} = {\sum }_{i = 0}^{i = n} ( - {y}_{i} * log ( {p}_{i} ) - ( 1 - {y}_{i} ) * log ( 1 - {p}_{i} ) ) \qquad Eqn . 4$$

Herein, ‘n’ is the total number of data points in the imbalanced input dataset 218, ‘yᵢ’ represents a true label for the sensitive attribute (0 or 1), and ‘pᵢ’ represents the predicted probability of the sensitive attribute being 1. The embedding generation loss value may be used further for optimization of the architecture for de-biasing.

Further, for individual data points an overall loss value (L) may be computed using the following equation:

$$L = {L}_{r} + β * {L}_{s} + α * {L}_{g} \qquad Eqn . 5$$

Herein, ‘β’ and ‘α’ corresponds to scalar values which are some of the hyperparameters which may be taken to in a range of values between 1 and 4 each. Thus, it may be understood that the overall loss value for each data point can be a linear combination of the embedding generation loss value, the first loss value, and the second loss value.

This overall loss value may have to be optimized and hence all these steps may be performed iteratively (see, 316), until the overall loss value for each data point after every iteration reduces. In various non-limiting examples, to further optimize the operation, the optimal values for the weights that need to be assigned to each data point may be computed using the following equations:

$${max}_{w} \sum {w}_{i} L ( {y}_{i} , {y}_{i}^{′} ) - α \sum {w}_{i}^{2} \qquad Eqn . 6$$

$$such that {\sum }_{i = 0}^{i = n} {w}_{i} = c , {w}_{i} >= 0 \qquad Eqn . 7$$

Herein, ‘wᵢ’ is the weight assigned to i^{th} sample, ‘L’ is an overall loss function for the i^{th} sample, ‘y’ is the true label, ‘yᵢ’ is the predicted label, ‘α’ controls the number of samples that obtain non-zero weights, and ‘c’ limits the sum of weights for each sample. Herein, the above equations 6 and 7 and the parameter ‘c’ are decided using the concept of adaptive reweighing (optimization) (see, 318) described earlier with reference to FIG. 2.

Later, in an embodiment, a loss function for the plurality of data points in the imbalanced input dataset 218 is defined as a weighted sum of the individual overall losses for each data point. In a non-limiting example, the equation of this loss function is as follows:

$${L}_{overall} = {\sum }_{i ∈ D} {W}_{i} * {L}_{i} \qquad Eqn . 8$$

Herein, ‘Wᵢ’ is the weight assigned to the i^{th} sample, ‘Lᵢ’ is the L of the i^{th} sample, and ‘D’ is the collection of all the samples in the dataset.

It should be noted that the assignment of weights to samples ensures that the classifier prioritizes instances that are either misclassified or have a higher likelihood of being misclassified. Achieving this balance involves constraints that regulate the sum of weights. Moreover, this helps in boosting overall model performance.

In a non-limiting implementation, the improvement in the model performance has been tested by conducting an experiment. For accurately measuring the model performance of the first classification model 222, a set of evaluation metrics may be measured, such as accuracy, a disparate impact, a disparate True Positive Rate (TPR), a disparate True Negative Rate (TNR), and the like.

As used herein, the term ‘accuracy’ refers to a metric that measures how often a model can correctly predict outcomes. The ratio of correct predictions to the total number of predictions provides the accuracy of the model and in binary classification, both true positive (TP) and true negative (TN) predictions may be considered.

As used herein, the term ‘disparate impact’ refers to a metric that is the difference in positive outcome rate between two different demographic groups. It may be noted that the lesser the value of this metric is, the better it is. In an ideal scenario, the value of this metric should be zero.

As used herein, the term ‘disparate TPR’ refers to a metric that is the difference in TPR of two different groups. If the result is significantly different, it suggests potential bias in how well the model identifies positive instances for each group. In other words, this metric is also supposed to be close to zero, the closer the better. Ideally, it should be zero.

As used herein, the term ‘disparate TNR’ refers to a metric that is the difference in TNR of two different groups. If the result is substantially different, it indicates potential bias in how well the model identifies negative instances for each group. In other words, this metric is also supposed to be close to zero, the closer the better. Ideally, it should be zero.

It may be understood that these metrics are measured for a set of conventional approaches as shown in Table 1. In an example implementation, ‘A’ from the table may be an adaptive reweighing-based approach, ‘B’ may be a federated learning and adversarial de-biasing-based approach, and ‘C’ may be a logarithmic regression-based approach.

TABLE 1
Results for Adult dataset

| Evaluation metrics | A | B | C | Present disclosure |
|---|---|---|---|---|
| Accuracy | 81.67 | — | 85.44 | 85.24 |
| Disparate impact | 17.14 | — | 15.20 | 15.41 |
| Disparate TPR | 1.74 | 8.00 | 1.53 | 3.87 |
| Disparate TNR | 7.17 | — | 5.71 | 5.64 |

It may be noted that the results for the evaluation metrics shown in Table 1 are measured by considering the imbalanced input dataset 218 to be a publicly available adult dataset. Also, it may be noted that the results in Table 1 are approximate and experimental in nature and may be associated with errors of about +4-5%. Moreover, the reproduction of these experiments may not generate the same results. From Table 1, it may be observed that the accuracy of the approach proposed in the present disclosure is much better than the considered prior arts. Also, it may be observed that even if the disparate TPR has increased, the disparate impact and disparate TPR have decreased. As a result, the overall performance of the model can be considered to be improved in comparison to the considered prior arts.

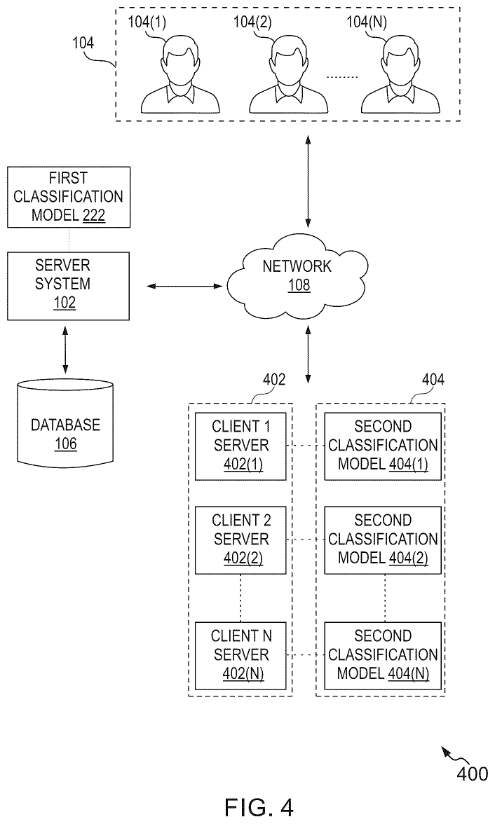

FIG. 4 illustrates a block diagram for performing a federated learning mechanism within an environment 400 related to at least some example embodiments of the present disclosure. Although the environment 400 is presented in one arrangement, other embodiments may include the parts of the environment 400 (or other parts) arranged otherwise depending on, operations performed similar to that performed in the environment 100. Thus, it should be noted that the environment 400 is an example implementation of the environment 100 described with reference to FIG. 1A, where federated learning has to be performed in a decentralized setup. In the decentralized setup where privacy or security concerns are associated with centralized data, a federated learning-based mechanism may be employed for de-biasing the one or more AI or ML models. Such a setup may be important in applications, such as healthcare, finance, personalized services, or the like.

In a non-limiting implementation, when the federated learning-based mechanism is applied to such applications, an AI or ML model may be trained across multiple decentralized servers that store local datasets that cannot be exchanged between the corresponding servers due to privacy concerns. The training of the model may be performed on each server based on local data on the corresponding servers. The model parameters, insights, or gradients are then shared, aggregated, and updated collaboratively.

In one embodiment, the environment 400 includes entities such as, the server system 102, a set of client servers 402 including a client 1 server 402(1), a client 2 server 402(2), . . . 402(N) (collectively, interchangeably referred to hereinafter simply as ‘client servers 402’), the plurality of users 104, and the database 106 each coupled to, and in communication with (and/or with access to) the network 108. Herein, it may be noted that ‘N’ is a non-zero natural number that may be different for different entities.

In such an implementation, the server system 102 may correspond to a central server that is involved in training the AI or ML model such as the first classification model 222 to perform a downstream task such as a binary classification task (e.g., payment industry-related task as described earlier with reference to FIG. 1B). As may be understood, the first classification model 222 can be associated with the above-mentioned biases. As a result, the server system 102 proposed in the present disclosure can be used to de-bias the first classification model 222.

In an embodiment, to mitigate the bias related to sensitive attributes corresponding to the users 104 from the predictions made using the first classification model 222, information or features related to the sensitive attributes may have to be suppressed from the imbalanced input dataset 218. However, it may be noted that such information is not available at the server system 102. However, the same information may be available at one or more of the client servers 402. In one embodiment, the client servers 402 may refer to servers associated with any client or entity that has access to the user's personal information, such as information related to the one or more sensitive attributes associated with the users 104. Further, in an embodiment, since the client servers 402 have access to the one or more sensitive attributes of the users 106, the client servers 402 can be involved in training and implementing one or more second classification models 404(1), 404(2), . . . 404(N) for performing the task of predicting a sensitive attribute label for a particular sensitive attribute at the set of client servers 402 including a client 1 server 402(1), a client 2 server 402(2), . . . 402(N), respectively. Herein, the second classification models 404(1), 404(2), . . . 404(N) are examples of the second classification model 224 of FIG. 2. Insights thus obtained from such training may be backpropagated to the server system 102 to eliminate bias while training the first classification model 222 at the server system 102.

In a specific implementation, the payment industry may include the set of client servers 402 that can include at least one of one or more issuer servers associated with one or more issuing banks, one or more acquirer servers associated with one or more acquiring banks, and a combination thereof, as explained in FIG. 1B. Thus, in one embodiment, one or more or the set of client servers 402 may be trained to predict the sensitive attributes of the users 104. The operations performed by the server system 102 and the set of client servers 402 are similar to those described earlier with reference to FIG. 1A, FIG. 1B to FIG. 3, therefore these operations are not described again here for the sake of brevity.

In a non-limiting implementation, the client server (e.g., the client 1 server 402(1)) may be configured to predict at least one sensitive attribute such as gender, whereas other client servers 402 may be configured to predict other sensitive attributes each, such as race, ethnicity, location, and the like. Depending upon which sensitive attribute-specific bias the user 104(2) is willing to mitigate from the predictions made by the first classification model 222, a corresponding client server may be selected, and the sensitive task request may be transmitted to the corresponding client server. The process after this stage is similar to that described earlier with reference to FIG. 1A, FIG. 1B to FIG. 3, therefore the same is not described again here for the sake of brevity.

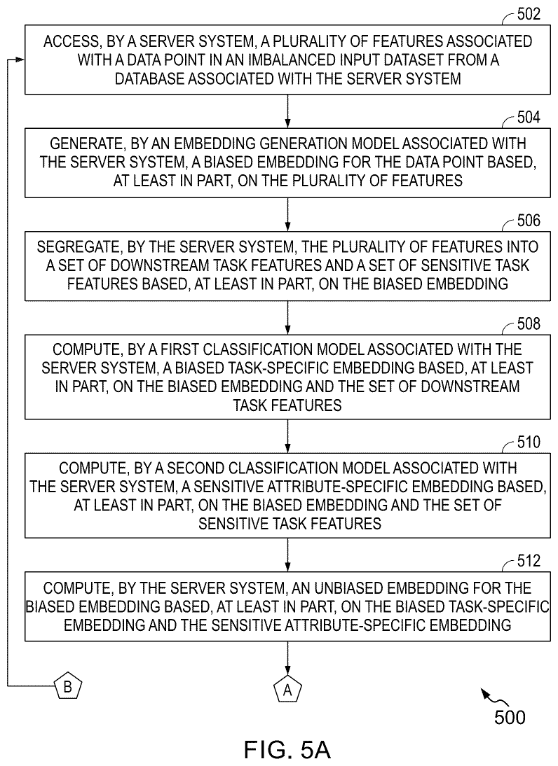

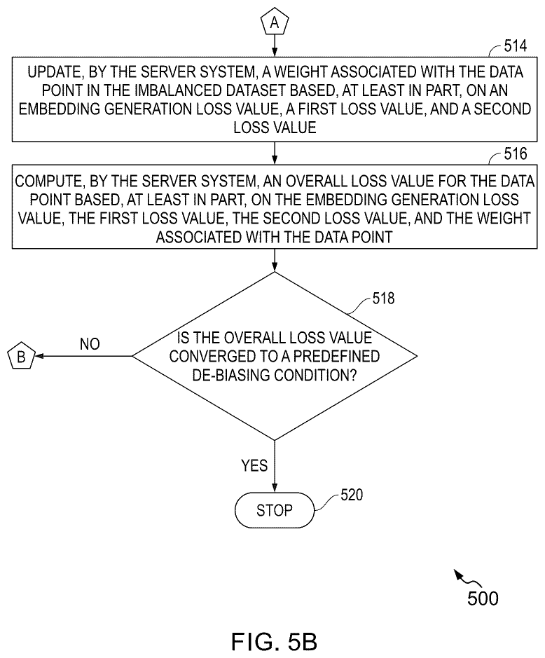

FIGS. 5A and 5B, collectively, illustrate a flow diagram depicting a method 500 for de-biasing an ML model, in accordance with an embodiment of the present disclosure. The method 500 depicted in the flow diagram may be executed by, for example, the server system 200. The sequence of operations of the method 500 may not be necessarily executed in the same order as they are presented. Further, one or more operations may be grouped and performed in the form of a single step, or one operation may have several sub-steps that may be performed in parallel or in a sequential manner. Operations of the method 500, and combinations of operations in the method 500 may be implemented by, for example, hardware, firmware, a processor, circuitry, and/or a different device associated with the execution of software that includes one or more computer program instructions. The plurality of operations is depicted in the process flow of the method 500. The process flow starts at operation 502. Herein, it should be noted that these operations may be repeated for the plurality of data points of the imbalanced input dataset 218.

At operation 502, the method 500 includes accessing, by a server system (such as the server system 200), a plurality of features associated with a data point in an imbalanced input dataset (such as the imbalanced input dataset 218) from a database (such as the database 204) associated with the server system 200.

At operation 504, the method 500 includes generating, by an embedding generation model (such as the embedding generation model 220) associated with the server system 200, a biased embedding for the data point based, at least in part, on the plurality of features.

At operation 506, the method 500 includes segregating, by the server system 200, the plurality of features into a set of downstream task features and a set of sensitive task features based, at least in part, on the biased embedding.

At operation 508, the method 500 includes computing, by a first classification model (such as the first classification model 222) associated with the server system 200, a biased task-specific embedding based, at least in part, on the biased embedding and the set of downstream task features.

At operation 510, the method 500 includes computing, by a second classification model (such as the second classification model 224) associated with the server system 200, a sensitive attribute-specific embedding based, at least in part, on the biased embedding and the set of sensitive task features.

At operation 512, the method 500 includes computing, by the server system 200, an unbiased embedding for the biased embedding based, at least in part, on the biased task-specific embedding and the sensitive attribute-specific embedding.

At operation 514, the method 500 includes updating, by the server system 200, a weight associated with the data point in the imbalanced input dataset 218 based, at least in part, on an embedding generation loss value, a first loss value, and a second loss value.

At operation 516, the method 500 includes computing, by the server system 200, an overall loss value for the data point based, at least in part, on the embedding generation loss value, the first loss value, the second loss value, and the weight associated with the data point.

At operation 518, the method 500 includes determining if the overall loss value is converged to a predefined de-biasing condition. In one embodiment, if the overall loss value converges to the predefined de-biasing condition, then the process flow moves to operation 520, otherwise, the process flow moves back to operation 502 and the steps of the method 500 are repeated until the overall loss value converges to the predefined de-biasing condition. At operation 520, the process stops.

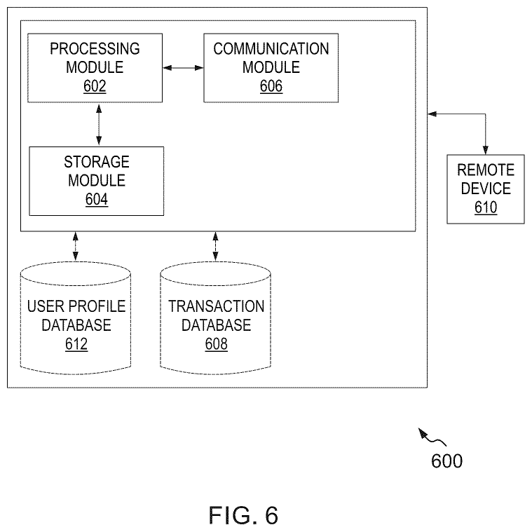

FIG. 6 illustrates a simplified block diagram of an acquirer server 600, in accordance with an embodiment of the present disclosure. The acquirer server 600 is an example of the acquirer servers 148 of FIG. 1B. The acquirer server 600 is associated with an acquirer bank/acquirer, in which a merchant may have an account, which provides a payment card. The acquirer server 600 includes a processing module 602 operatively coupled to a storage module 604 and a communication module 606. The components of the acquirer server 600 provided herein may not be exhaustive, and the acquirer server 600 may include more or fewer components than those depicted in FIG. 6. Further, two or more components may be embodied in one single component, and/or one component may be configured using multiple sub-components to achieve the desired functionalities. Some components of the acquirer server 600 may be configured using hardware elements, software elements, firmware elements, and/or a combination thereof.

The storage module 604 is configured to store machine-executable instructions to be accessed by the processing module 602. Additionally, the storage module 604 stores information related to, the contact information of the merchant, bank account number, availability of funds in the account, payment card details, transaction details, and/or the like. Further, the storage module 604 is configured to store payment transactions and preauthorization (pre-auth) transactions associated with the merchant.

In one embodiment, the acquirer server 600 is configured to store profile data (e.g., an account balance, a credit line, details of the merchant 144, and account identification information) in a transaction database 608. The details of the merchant 144 may include, but are not limited to, name, physical attributes, location, registered contact number, family information, alternate contact number, registered e-mail address, etc.

The processing module 602 is configured to communicate with one or more remote devices such as a remote device 610 using the communication module 606 over a network such as the network 108 of FIG. 1A. The examples of the remote device 610 include the server system 102, the payment server 152, the issuer servers 146, or other computing systems of the acquirer server 600, and the like. The communication module 606 is capable of facilitating such operative communication with the remote devices and cloud servers using Application Program Interface (API) calls. The communication module 606 is configured to receive a payment transaction request performed by the cardholders 142 via the network 108. The processing module 602 receives payment card information, a payment transaction amount, cardholder information, and merchant information from the remote device 610 (i.e., the payment server 152). The acquirer server 600 includes a user profile database 612 and the transaction database 708 for storing transaction data. The user profile database 612 may include information about the cardholders 142. The transaction data may include, but is not limited to, transaction attributes, such as transaction amount, source of funds such as bank or credit cards, transaction channel used for loading funds such as POS terminal or ATM, transaction velocity features such as count and transaction amount sent in the past x days to a particular user, transaction location information, external data sources, pre-auth transactions, and other internal data to evaluate each transaction.

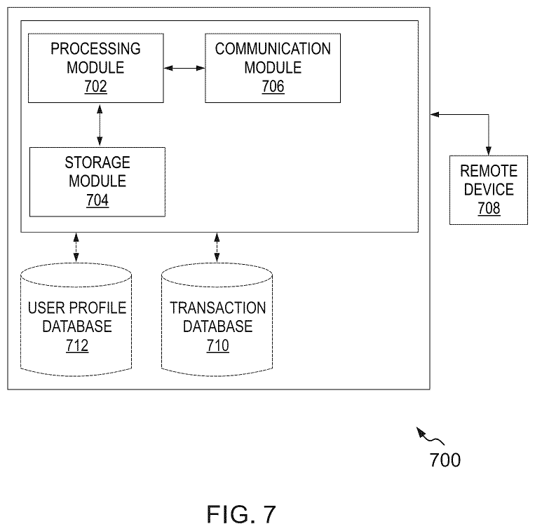

FIG. 7 illustrates a simplified block diagram of an issuer server 700, in accordance with an embodiment of the present disclosure. The issuer server 700 is an example of the issuer servers 146 of FIG. 1B. The issuer server 700 is associated with an issuer bank/issuer, in which an account holder (e.g., the cardholders 142(1)-142(N)) may have an account, which provides a payment card. The issuer server 700 includes a processing module 702 operatively coupled to a storage module 704 and a communication module 706. The components of the issuer server 700 provided herein may not be exhaustive and the issuer server 700 may include more or fewer components than those depicted in FIG. 7. Further, two or more components may be embodied in one single component, and/or one component may be configured using multiple sub-components to achieve the desired functionalities. Some components of the issuer server 700 may be configured using hardware elements, software elements, firmware elements, and/or a combination thereof.

The storage module 704 is configured to store machine-executable instructions to be accessed by the processing module 702. Additionally, the storage module 704 stores information related to, the contact information of the cardholders (e.g., the cardholders 142(1)-142(N)), a bank account number, availability of funds in the account, payment card details, transaction details, payment account details, and/or the like. Further, the storage module 704 is configured to store payment transactions and preauthorization transactions associated with the cardholders 142.

In one embodiment, the issuer server 700 is configured to store profile data (e.g., an account balance, a credit line, details of the cardholders 142, account identification information, payment card number, etc.) in a database. The details of the cardholders 142 may include, but are not limited to, name, physical attributes, location, registered contact number, family information, alternate contact number, registered e-mail address, or the like of the cardholders 142.

The processing module 702 is configured to communicate with one or more remote devices such as a remote device 708 using the communication module 706 over a network such as the network 108 of FIG. 1A. Examples of the remote device 708 include the server system 200, the payment server 152, the acquirer servers 148, or other computing systems of the issuer server 700. The communication module 706 is capable of facilitating such operative communication with the remote device 708 and cloud servers using Application Program Interface (API) calls. The communication module 706 is configured to receive a payment transaction request performed by an account holder (e.g., the cardholder 142(1)) via the network 108. The processing module 702 receives payment card information, a payment transaction amount, customer (cardholder) information, and merchant information from the remote device 708 (e.g., the payment server 152). The issuer server 700 includes a transaction database 710 for storing transaction data. The transaction data may include, but is not limited to, transaction attributes, such as transaction amount, source of funds such as bank or credit cards, transaction channel used for loading funds such as POS terminal or ATM, preauthorization transactions, transaction velocity features such as count and transaction amount sent in the past x days to a particular account holder, transaction location information, external data sources, and other internal data to evaluate each transaction. The issuer server 700 includes a user profile database 712 storing user profiles associated with the plurality of account holders.

The user profile data may include an account balance, a credit line, details of the account holders, account identification information, payment card number, or the like. The details of the account holders (e.g., the cardholders 142(1)-142(N)) may include, but are not limited to, name, age, gender, physical attributes, location, registered contact number, family information, alternate contact number, registered e-mail address, or the like of the cardholders 142.

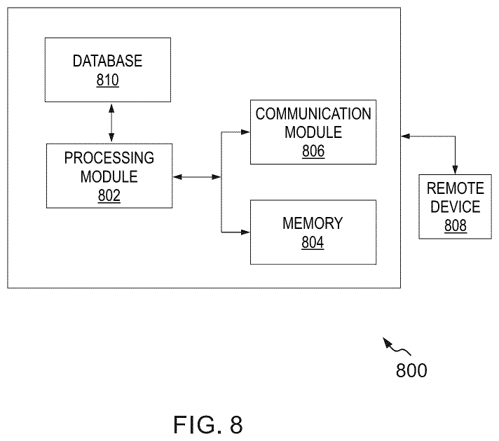

FIG. 8 illustrates a simplified block diagram of the payment server 800, in accordance with an embodiment of the present disclosure. The payment server 800 is an example of the payment server 152 of FIG. 1B. The payment server 800 and the server system 200 may use the payment network 150 as a payment interchange network.

The payment server 800 includes a processing module 802 configured to extract programming instructions from a memory 804 to provide various features of the present disclosure. The components of the payment server 800 provided herein may not be exhaustive, and the payment server 800 may include more or fewer components than that depicted in FIG. 9. Further, two or more components may be embodied in one single component, and/or one component may be configured using multiple sub-components to achieve the desired functionalities. Some components of the payment server 800 may be configured using hardware elements, software elements, firmware elements, and/or a combination thereof.

Via a communication module 806, the processing module 802 receives a request from a remote device 808, such as the issuer servers 146, the acquirer servers 148, or the server system 102. The request may be a request for conducting the payment transaction. The communication may be achieved through API calls, without loss of generality. The payment server 800 includes a database 810. The database 810 also includes transaction processing data such as issuer ID, country code, acquirer ID, and merchant identifier (MID), among others.

When the payment server 800 receives a payment transaction request from the acquirer servers 148 or a payment terminal (e.g., IoT device), the payment server 800 may route the payment transaction request to the issuer servers 146. The database 810 stores transaction identifiers for identifying transaction details such as transaction amount, IoT device details, acquirer account information, transaction records, merchant account information, and the like.

In one example embodiment, the acquirer servers 148 are configured to send an authorization request message to the payment server 800. The authorization request message includes, but is not limited to, the payment transaction request.

The processing module 802 further sends the payment transaction request to the issuer servers 146 for facilitating the payment transactions from the remote device 808. The processing module 802 is further configured to notify the remote device 808 of the transaction status in the form of an authorization response message via the communication module 806. The authorization response message includes, but is not limited to, a payment transaction response received from the issuer servers 146. Alternatively, in one embodiment, the processing module 802 is configured to send an authorization response message for declining the payment transaction request, via the communication module 806, to the acquirer servers 148. In one embodiment, the processing module 802 executes similar operations performed by the server system 200, however, for the sake of brevity, these operations are not explained herein.

The disclosed method with reference to FIG. 5, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable CD-R, Compact Disc Rewritable (CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which, are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a plurality of features associated with a data point in an imbalanced input dataset from a database associated with the server system;
generating, by an embedding generation model associated with the server system, a biased embedding for the data point based, at least in part, on the plurality of features;
segregating, by the server system, the plurality of features into a set of downstream task features and a set of sensitive task features based, at least in part, on the biased embedding;
computing, by a first classification model associated with the server system, a biased task-specific embedding based, at least in part, on the biased embedding and the set of downstream task features;
computing, by a second classification model associated with the server system, a sensitive attribute-specific embedding based, at least in part, on the biased embedding and the set of sensitive task features; and
computing, by the server system, an unbiased embedding for the biased embedding based, at least in part, on the biased task-specific embedding and the sensitive attribute-specific embedding.

2. The computer-implemented method as claimed in claim 1, further comprising:
updating, by the server system, a weight associated with the data point in the imbalanced input dataset based, at least in part, on an embedding generation loss value, a first loss value, and a second loss value.

3. The computer-implemented method as claimed in claim 2, further comprising:
generating, by the embedding generation model, a reconstructed output for the data point based, at least in part, on the plurality of features; and
computing, by the server system, the embedding generation loss value associated with the embedding generation model based, at least in part, on the reconstructed output and an original input data point.

4. The computer-implemented method as claimed in claim 2, further comprising:
generating, by the first classification model, a prediction for the data point based, at least in part, on the unbiased embedding, the prediction being related to the main task; and
computing, by the server system, the first loss value associated with the first classification model based, at least in part, on the prediction and an actual outcome for the data point.

5. The computer-implemented method as claimed in claim 2, further comprising:
generating, by the second classification model, a sensitive attribute prediction for the data point based, at least in part, on the sensitive attribute-specific embedding; and
computing, by the server system, the second loss value associated with the second classification model based, at least in part, on the sensitive attribute prediction and an actual sensitive attribute of the data point.

6. The computer-implemented method as claimed in claim 2, further comprising:
computing, by the server system, an overall loss value for the data point based, at least in part, on the embedding generation loss value, the first loss value, the second loss value, and the weight associated with the data point.

7. The computer-implemented method as claimed in claim 6, further comprising:
de-biasing the first classification model based, at least in part, on computing the overall loss value for the data point until the overall loss value converges to a predefined de-biasing condition.

8. The computer-implemented method as claimed in claim 1, further comprising:
training, by the server system, the embedding generation model to generate the biased embedding for a training dataset based, at least in part, on performing a first set of operations until an embedding generation loss value converges to a first predefined condition, the first set of operations comprising:
initializing the embedding generation model based, at least in part, on one or more embedding generation model parameters;
generating, by an encoder of the embedding generation model, the biased embedding based, at least in part, on the plurality of features;
generating, by a decoder of the embedding generation model, a reconstructed output based, at least in part, on the biased embedding;
computing the embedding generation loss value based, at least in part, on the reconstructed output, an original input, and an embedding generation loss function;
computing an embedding generation gradient component based, at least in part, on backpropagating the embedding generation loss value; and
optimizing the one or more embedding generation model parameters based, at least in part, on the embedding generation gradient component.

9. The computer-implemented method as claimed in claim 1, further comprising:
training, by the server system, the first classification model to generate the biased task-specific embedding for a training dataset based, at least in part, on performing a second set of operations until a first loss value converges to a second predefined condition, the second set of operations comprising:
initializing the first classification model based, at least in part, on one or more first classification model parameters;
generating, by the first classification model, the biased task-specific embedding based, at least in part, on the biased embedding and the set of downstream task features;
generating, by the first classification model, a prediction corresponding to the downstream task based, at least in part, on the biased task-specific embedding;
computing the first loss value based, at least in part, on the prediction, a true task-specific label, and a first loss function;
computing a first gradient component based, at least in part, on backpropagating the first loss value; and
optimizing the one or more first classification model parameters based, at least in part, on the first gradient component.

10. The computer-implemented method as claimed in claim 1, further comprising:
training, by the server system, the second classification model to generate the sensitive attribute-specific embedding for a training dataset based, at least in part, on performing a third set of operations until a second loss value converges to a third predefined condition, the third set of operations comprising:
initializing the second classification model based, at least in part, on one or more second classification model parameters;
generating, by the second classification model, the sensitive attribute-specific embedding based, at least in part, on the biased embedding and the set of sensitive task features;
generating, by the second classification model, a prediction corresponding to a sensitive attribute classification task based, at least in part, on the sensitive attribute-specific embedding;
computing the second loss value based, at least in part, on the prediction, a true sensitive attribute label, and a second loss function;
computing a second gradient component based, at least in part, on backpropagating the second loss value; and
optimizing the one or more second classification model parameters based, at least in part, on the second gradient component.

11. The computer-implemented method as claimed in claim 1, wherein steps of the claim 1 are performed for each data point of a plurality of data points in the imbalanced input dataset.

12. The computer-implemented method as claimed in claim 1, further comprising:
accessing, by the server system, the imbalanced input dataset from the database, the imbalanced input dataset comprising historical information corresponding to the at least one user, the historical information comprising a plurality of data points having an imbalanced label distribution;
generating, by the server system, the plurality of features for each data point corresponding to the at least one user based, at least in part, on the imbalanced input dataset; and
storing, by the server system, the plurality of features for the at least one user in the database.

13. The computer-implemented method as claimed in claim 1, further comprising:
transmitting, by the server system, a sensitive task request to a set of client servers, the sensitive task request indicating a request for a sensitive attribute-specific embedding for a sensitive attribute corresponding to the at least one user, the sensitive task request comprising the biased embedding; and
in response to the sensitive task request, receiving, by the server system, the sensitive attribute-specific embedding from the set of client servers, wherein the sensitive attribute-specific embedding is computed by the second classification model associated with the set of client servers.

14. A server system, comprising:
a communication interface;
a memory comprising executable instructions; and
a processor communicably coupled to the communication interface and the memory, the processor configured to cause the server system to at least:
access a plurality of features associated with a data point in an imbalanced input dataset from a database associated with the server system;
generate, by an embedding generation model associated with the server system, a biased embedding for the data point based, at least in part, on the plurality of features;
segregate the plurality of features into a set of downstream task features and a set of sensitive task features based, at least in part, on the biased embedding;
compute, by a first classification model associated with the server system, a biased task-specific embedding based, at least in part, on the biased embedding and the set of downstream task features;
compute, by a second classification model associated with the server system, a sensitive attribute-specific embedding based, at least in part, on the biased embedding and the set of sensitive task features; and
compute an unbiased embedding for the biased embedding based, at least in part, on the biased task-specific embedding and the sensitive attribute-specific embedding.

15. The server system as claimed in claim 14, wherein the server system is further caused, at least in part, to:
update a weight associated with the data point in the imbalanced input dataset based, at least in part, on an embedding generation loss value, a first loss value, and a second loss value.

16. The server system as claimed in claim 15, wherein the server system is further caused, at least in part, to:
generate, by the embedding generation model, a reconstructed output for the data point based, at least in part, on the plurality of features; and
compute the embedding generation loss value associated with the embedding generation model based, at least in part, on the reconstructed output and an original input data point.

17. The server system as claimed in claim 15, wherein the server system is further caused, at least in part, to:
generate, by the first classification model, a prediction for the data point based, at least in part, on the unbiased embedding, the prediction being related to the main task; and
compute the first loss value associated with the first classification model based, at least in part, on the prediction and an actual outcome for the data point.

18. The server system as claimed in claim 15, wherein the server system is further caused, at least in part, to:
generate, by the second classification model, a sensitive attribute prediction for the data point based, at least in part, on the sensitive attribute-specific embedding; and
compute the second loss value associated with the second classification model based, at least in part, on the sensitive attribute prediction and an actual sensitive attribute of the data point.

19. The server system as claimed in claim 15, wherein the server system is further caused, at least in part, to:
compute an overall loss value for the data point based, at least in part, on the embedding generation loss value, the first loss value, the second loss value, and the weight associated with the data point.

20. A non-transitory computer-readable storage medium comprising computer-executable instructions that, when executed by at least a processor of a server system, cause the server system to perform a method comprising:
accessing a plurality of features associated with a data point in an imbalanced input dataset from a database associated with the server system;
generating, by an embedding generation model associated with the server system, a biased embedding for the data point based, at least in part, on the plurality of features;
segregating the plurality of features into a set of downstream task features and a set of sensitive task features based, at least in part, on the biased embedding;
computing, by a first classification model associated with the server system, a biased task-specific embedding based, at least in part, on the biased embedding and the set of downstream task features;
computing, by a second classification model associated with the server system, a sensitive attribute-specific embedding based, at least in part, on the biased embedding and the set of sensitive task features; and
computing an unbiased embedding for the biased embedding based, at least in part, on the biased task-specific embedding and the sensitive attribute-specific embedding.
